(19) United States
(12) Patent Application Publication
(10) Pub. No.: US 2025/0205956 A1
(43) Pub. Date: Jun. 26, 2025

(54) METHOD AND APPARATUS FOR MANUFACTURING AN EXTRUDED SHEET

(71) Applicant: UNILIN, BV, Wielsbeke (BE)

(72) Inventors: Christophe NAEYAERT, Wielsbeke (BE); Martin SEGAERT, Wielsbeke (BE)

(21) Appl. No.: 18/849,690

(22) PCT Filed: Mar. 28, 2023
(86) PCT No.: PCT/IB2023/053067

§ 371 Date: Sep. 23, 2024

Related U.S. Application Data
(60) Provisional application No. 63/327,032, filed on Apr. 4, 2022.

(51) Int. Cl. B29C 48/21; B29C 48/00; B29C 48/07; B29C 48/305; B29K 105/04; B29K 105/16; B29L 31/00

(52) U.S. Cl. CPC B29C 48/21; B29C 48/0011; B29C 48/022; B29C 48/07; B29C 48/305; B29K 2105/046; B29K 2105/16; B29L 2031/732

(57) ABSTRACT

A method for manufacturing an extruded sheet wherein the sheet is extruded through the opening of a die. The die is fed by an extruder. The die forms an inclination angle (A-A′) with the horizontal plane. An apparatus is provided for use in such method.

The present invention pertains to the technical field of methods for manufacturing extruded sheets. Further, the invention relates to an apparatus for manufacturing extruded sheets. More particularly, the invention relates to extruded sheets that are suitable for forming the substrate or one or more substrate layers of a coated panel, such as a floor panel.

Forming floor panels based on a sheet obtained by an extrusion process is known per se, for example, from EP3703926. The example method of EP'926 includes providing a filler and polymer in powder form, optionally providing additives, such as stabilizers, and heating the obtained mixture until the polymer powder softens to form a kneadable mass and filler powder at least partially bonds thereto. The obtained mass is subjected to cooling; and is subsequently conveyed to an extruder; wherein melting and extruding the mass by means of an extruder happens. The extruder feeds a die, and the sheet is extruded through the opening of the die. The obtained sheet is then pressed to a desired final thickness by means of, for example, calendar rolls.

However, different problems with respect to the mechanical quality and uniformity of the sheet may arise by following the processes of the prior art. The sheet which exits the die opening is still warm, soft and/or flexible, which makes said sheet particularly prone to mechanical deformations and/or different non-homogeneity issues. After exiting the die, the sheet must be transferred to conveying means, which sheet is typically dropped and/or let from a height onto said conveyor means. Such transfer may induce stress in the sheet and the mechanical properties, the evenness, and/or mechanical stability of the sheet may be impaired, leading to problems in further production steps and/or in use. Furthermore, the defects in such sheet may also lead to a loss of aesthetic properties of a finally obtained coated panel, comprising such sheet as a substrate or substrate layer and an applied thereon decorative top layer. Such uneven or inhomogeneous substrate or substrate layer may lead to variable results in a subsequent mechanical embossing operation of the decorative top layer, as the counterpressure exerted by the substrate varies. As a result undesired gloss differences and/or undesired variations in embossing depth may arise. Moreover, in sheets comprising highly filled extruded material, the occasional precipitation of the filler under the gravity force in the extruded sheet which is not yet solidified could be observed. The sheet wherein the precipitation of the filler occurs is non-homogenous and more prone to damage during the manufacturing, storing, transportation and/or installation. Such uneven distribution of the components of the sheet may impair also visual and sound characteristics of the sheet. The visual and sound characteristics are particularly important in sheets further used as a substrate or substrate layer in floor, wall and furniture panels.

The present invention, in the first place, aims to provide an alternative method for manufacturing an extruded sheet.

Furthermore, in accordance with one or more of the preferred embodiments, the present invention provides solutions to one or more problems associated with the manufacturing of sheets by methods according to the state of the art.

With this aim, the present invention in accordance with a first independent aspect is a method for manufacturing an extruded sheet wherein said sheet is extruded through the opening of a die, said die being fed by an extruder, with as a characteristic that said die forms an inclination angle with the horizontal plane and/or that the direction in which the extruded sheet leaves said opening forms an inclination angle with respect to said horizontal plane. By the non-horizontal exit of the sheet from the die opening effects of gravity can be controlled, i.e. minimized or maximized. The extruded sheet, after leaving the die opening, is preferably laid down on at least a first supporting means.

The inclination angle may be chosen in different possible ranges, having varying according effects.

According to a first possibility, said inclination angle is acute, namely higher than 0° and less than 90°, more preferably said inclination angle is from 1° to 60°, most preferably said inclination angle is from 3° to 30°, measured from the horizontal plane as an angle base, to the axis of the die and/or to the direction in which the extruded sheet leaves the opening of the die. According to this first possibility, the opening of the die faces the direction of motion of the sheet along the first supporting means. By providing a sharp inclination angle between the horizontal plane and the axile of the die, the effects of the gravity force on sedimentation effects can be controlled and/or adjusted. The sheet obtainable by a method where the inclination angle is a sharp angle can be more homogeneous than known sheets obtainable by the methods known in the art.

According to a second possibility, said inclination angle is obtuse, namely from 90° to less than 180°. According to this second possibility, the opening of the die faces away from the direction of the motion of the sheet along the first supporting means. Such inclination angle may be preferred when a sheet of a more dense material is to be made.

The first supporting means could be any suitable means for taking over and holding a sheet extruded by the method of the invention, and is positioned below the extruded sheet in order to support it against gravity. Upon the extrusion of the sheet, such means which comes first into contact with the extruded sheet is considered as the first supporting means. Said first supporting means may be, for example, a conveying belt, a roller, a whether or not flat or bent guiding surface, or the like.

In a preferred embodiment, said inclination angle is an acute angle, as measured clockwise starting from said horizontal plane as angle base, and with the direction of motion of the first supporting means pointing to the right. In this preferred practical embodiment the opening of the inclined die is pointing downwards. In such a position of the die, gravity may assist the extrusion to some extent, and sedimentation of e.g. filler material at the exit of the die, where the sheet is still soft, may be minimized. The internal composition of the sheet obtained in this way may be more homogeneous. Such a position may further allow for a delivery of the sheet with minimal stress, for example by laying down the sheet onto conveying means, which minimizes chances of defects and maximizes the evenness of the surfaces of the sheet.

In an alternative embodiment, the inclination angle is an acute angle, as measured counterclockwise starting from said horizontal plane as angle base, and with the direction of motion of the first supporting means pointing to the right. In this alternative practical embodiment, the inclined die has an opening which opening points upwards. With this orientation gravity may be made to slightly or greatly, depending on the inclination angle and extrusion pressure, counteract the extrusion, which may lead to a more dense sheet. At the same time, sedimentation of e.g. filler material at the exit of the die, where the sheet is still soft, may be minimized.

According to still further alternative embodiments, the inclination angle may be an obtuse angle from 90° to less than 180°, either as measured clockwise, or respectively counterclockwise starting from said horizontal plane as angle base, and with the direction of motion of the first supporting means pointing to the right, wherein the opening of the die and/or the direction in which the extruded sheet leaves the die opening is pointing downwards, respectively upwards.

In a preferred embodiment, the sheet is laid down on a first supporting means. Such first supporting means preferably extends at least to a horizontal position vertically underneath said opening of said die. In this way the sheet may be supported rather quickly after leaving the opening of the die, and the origination of internal mechanical stresses and consequent defects may be limited. Preferably the sheet is supported within the first 25 cm, as measured along the sheet length. In an alternative embodiment, said first supporting means may be positionable, for example a positionable roller, meaning that the position of the die in respect to the first supporting means, e.g. roller, can be changed also by moving and placing the supporting means in the desired position.

In a preferred embodiment, said laying down of said extruded sheet is done in a transitional let-down trajectory, wherein said sheet in said transitional let-down trajectory is bent. Preferably said sheet in said transitional let-down trajectory is free from bents or bent with radiuses of 10 cm or more. Preferably, said sheet in said transitional let-down trajectory is free from bents having a radius smaller than 10 cm. By laying down in a transitional, more smooth manner, the mechanical stress onto the extruded sheet is minimized and/or the sheet is of a more uniform appearance. Such sheet is characterized by improved mechanical characteristics. Due to more even surfaces, and uniform distribution of the components in the sheet, said sheet is of an improved aesthetic appearance. By avoiding bents with a radius smaller than 10 cm, a more gradual let-down is achieved, which leads to less mechanical stress during the sheet production, and improved mechanical characteristics.

In a preferred embodiment, said sheet is laid down on a roller, preferably having a radius of 10 cm or larger, and/or on a conveyor, for example on a conveyor belt. The method according to the first aspect of the invention is compatible with different supporting means and/or different equipment elements. According to a special embodiment, the inclination angle of the die may be such that the sheet exits the die tangentially or nearly tangentially to a roller. In this way, bending of the sheet in said transitional let-down trajectory can be minimized or even avoided, and the bent of the sheet as it moves along the first supporting means can be fixed by means of the radius of the respective roller. The roller may either deliver the sheet to a further roller, for example of a calibration and/or lamination unit, or to another conveyor means. The roller applied in the aforementioned special embodiment may be fixed, freely rotating, driven and/or braked. Driving or braking the roller may assist or, respectively, counteract the extrusion by pulling and/or pushing the extruded sheet.

In an alternative embodiment, the inclination angle may be adjustable and/or variable during said extruding of said sheet. In this way, the assistance or counteraction of gravity may be altered during extrusion, and, for example, steered on the basis of downstream measurements of the density and/or composition of the obtained sheet.

In a preferred embodiment, the method includes providing an additional sheet, wherein said additional sheet is extruded through the opening of an additional die, said additional die preferably being fed by an additional extruder, wherein said additional die is, preferably in the horizontal plane or at least less inclined than the die of the first aspect. The present preferred embodiment allows production of more complex, multilayered sheets, wherein the sheet mentioned in the first aspect and the additional sheet each form a layer of a multilayer sheet. Preferably, the additional sheet is of a different composition relative to the sheet mentioned in relation to the first aspect. Said sheets may be pressed or otherwise laminated together.

In a particularly preferred embodiment, the extruded sheet comprises an extruded polymer composition, wherein said polymer composition comprises polymer powder, filler materials and/or additives. The method of the invention is particularly suited for sheets comprising highly filled thermoplastic materials, wherein the content of the filler may be more than 50 wt. %, preferably more than 70 wt. %, more preferably about 80 wt. % or more.

Preferably, the method comprises the following steps:
providing of a polymer powder;
providing of a filler material, preferably in powder form, and/or additives;
mixing of the polymer powder, with the filler material and/or additives;
heating of the mixture to 90-160° C., until said mixture softens to become kneadable;
cooling of said mixture to 35 to 60° C.;
conveying the mixture to said extruder.

Preferably, the method further comprises the step of calibrating and/or compressing of the sheet while still warm to obtain a desired thickness. The step of compressing may lead to consolidation of the layers, especially in case of a multilayered sheet, and improves the mechanical characteristic of said sheet, as well as the evenness of said sheet.

Preferably, the method comprises providing of a filler material, said filler material preferably comprising calcium carbonate, limestone, dolomite and/or clay. It should be understood by a skilled person that any kind of filler material may be provided, without departing from the scope of the invention. In a preferred embodiment, the polymer composition comprises filler material in amount 50-90 wt. %, and a polymer in amount of 10-40 wt. %.

In this particularly preferred embodiment, said mixture which is to be extruded may comprise further additives, said additives preferably being at least a stabilizer, a plasticizer and/or an impact modifier. The mixture may further comprise colorants, rheology modifiers and/or lubricants, pH additives, solvents and the like.

In a first possibility of said particularly preferred embodiment, said polymer powder comprises polyester.

Preferably, said polyester is polyethylene terephthalate (PET). PET may be suited as an available and recyclable alternative to other polymer materials, and is suited to be processed by the method of the invention.

In a second possibility, the polymer powder comprises polyvinylchloride (PVC). PVC is particularly suitable for provision of highly filled substrates. According to the present second possibility the method preferably comprises mixing of the filler material and polyvinylchloride (PVC) and optionally additives, and heating to 100 to 140° C., until the mixture softens to become kneadable. Preferably, 60-80 wt. % of a filler is mixed with 20-40 wt. % of polyvinylchloride, forming said polymer, and up to 5 wt. % of additives. Preferably, said filler is predominantly calcium carbonate.

In a third possibility, the polymer powder comprises polyolefins, such as polyethylene (PE), polypropylene (PP) and the like.

According to the most preferred embodiment, said polymer powder is polyvinyl chloride (PVC), and said additives comprise less than 5% phr of plasticizer or said composition is plasticizer-free. The method of the invention is particularly suited for producing sheets of highly filled, rigid PVC. It is especially in highly filled sheets of thermoplastic polymers having a relatively low glass transition temperature, that sedimentation of the filler and induction of residual mechanical stress may appear. The present invention provides means for minimizing these effects.

It is noted that, in general, said extruded sheet may comprise a foamed layer or may be a foamed layer formed from a polymer composition, for example a polymer composition as mentioned in any of the possibilities of said particularly preferred embodiment. Preferably the composition comprises PVC and filler material. Preferably the foamed layer is a layer of a closed cell foam, i.e. a foam wherein at least the majority of the foam cells are closed or completely surrounded by a cell wall. The inventor has found that the inclination angle of the die, in accordance with the invention, is of particular interest for manufacturing extruded sheets comprising or being a foamed layer. The inclination can to some extent control the thickness and quality of possible crust layers, i.e. unfoamed or less foamed surface layers at the surface of the foamed layer. Preferably the thickness of a crust layer is smaller than 200 micrometer, and/or less than 5% of the total thickness of the foamed layer.

For working with a foamed layer an inclination angle of the die in accordance with the first possibility therefor, namely an acute angle, preferably smaller than 30°, measured from the horizontal plane as an angle base to the axis of the die, is preferred. The opening of the die hereby faces the direction of motion of the sheet along the first supporting means. Preferably the first supporting means comprises a roller. In the most preferred embodiment the sheet exits the die tangentially or nearly tangentially to said roller. Preferably the sheet is introduced into a nip formed between said roller and a counter roller. The set of roller and counter roller may serve to perform a thickness calibration on the extruded sheet.

In case the present invention is used for extruding sheets comprising a foamed layer or being a foamed layer, such foamed layer preferably comprises filler materials at a weight ratio filler: polymer of below 2.5:1, and preferably above 0.75:1. Preferably the filler material is, or comprises CaCO3 or another inorganic material, e.g. in particle form.

Potential foaming within the extruded sheet is preferably obtained through injection of gas into the extruder, for example injection of CO2, N2 or air. According to variants chemical foaming agents may be added to the composition to be extruded.

The sheet obtained by the method of the invention may be provided with a wear and/or decorative layer.

In that case, preferably, the method of the invention further comprises the steps of:
providing a decorative layer and/or a wear layer, which decorative layer and/or wear layer are preferably passed over at least a calendaring roll; and
preferably pressing said decorative layer and/or said wear layer together with the sheet, preferably by a calendaring operation or a double belt press, in order to form a panel.

The enhanced properties of the sheet obtained by the method of the present invention makes it better applicable as the substrate for a coated panel, such as a floor panel, wall panel, ceiling panel or furniture panel. It is clear that according to an additional, particular independent aspect, the invention also concerns a method for producing a coated panel, wherein the panel comprises a sheet obtainable by a method of the first aspect of the invention and wherein said sheet is further provided with a wear and/or decorative layer.

Preferably, said decorative layer is a polyvinylchloride (PVC) decorative layer and/or said wear layer is a polyvinyl chloride (PVC) wear layer, preferably a rigid polyvinyl chloride (PVC) wear layer.

Alternatively, said decorative layer may be a polyolefin film, such as a PP film, or a polyester film, such as PET and/or polyester modified films, such as glycol modified polyethylene terephthalate (PETG) films.

Alternatively, the decorative layer may be in a form of a print directly printed onto a sheet surface, preferably with the intermediate of one or more primer and/or background layers.

Preferably, in said particularly preferred embodiment, the method comprises the further step of providing a lacquer layer on the uppermost side of the formed panel, preferably after pressing or otherwise laminating said decorative layer and/or said wear layer together with said sheet. Preferably, an UV curable lacquer, such as acrylic lacquer is applied as an uppermost layer onto the panel. In an alternative embodiment, an electron-beam curable lacquer layer may be used.

In a further preferred embodiment, the method of invention further comprises embossing of the sheet or a panel comprising said sheet and a decorative layer and/or a wear layer. Preferably said embossing step is performed on said panel, the embossing being in register with the decorative layer. In such manner, an improved look of a more natural appearance of the panel is achieved. Due to the enhanced properties of the sheet obtained through the method of the present invention, the embossing may be performed more evenly without undesired gloss differences.

With the same aim as in the first aspect, the present invention in accordance with a second independent aspect is an apparatus for manufacturing an extruded sheet, the apparatus comprising at least an extruder section with a die, with as a characteristic that said die is configured to form an inclination angle to a horizontal plane and/or said die is configured to allow the direction in which the extruded sheet leaves the opening of said die forming an inclination angle with respect to said horizontal plane.

According to a first possibility of said second independent aspect, said die is configured to form an inclination angle higher than 0° and less than 90°, more preferably an inclination angle from 1° to 60°, most preferably an inclination angle is from 3° to 30°.

According to a second possibility of said independent aspect, said die is configured to form an inclination angle from 90° to less than 180°.

In a preferred embodiment, the inclination angle is a negative angle, as measured counterclockwise starting from said horizontal plane as angle base. In this preferred practical embodiment the opening of the inclined die of the apparatus is pointing downwards.

According to an alternative embodiment, said angle is a positive angle, as measured counterclockwise starting from said horizontal plane as angle base. In this alternative practical embodiment, the inclined die in the apparatus of the invention has an opening which opening points upwards.

In an alternative embodiment, the inclination angle of the die of the apparatus may be adjustable and/or variable during the operation of the apparatus.

In a preferred embodiment, the apparatus according to the second aspect of the invention further comprises at least a first supporting means. Preferably, said first supporting means comprises a roller or a conveyor. The apparatus of the second independent aspect of the invention is suitable to include and/or to be combined with various processing elements which may be used as conveying means.

In a preferred embodiment, the apparatus further comprises a mixing barrel and/or a thermoregulating barrel preferably equipped by a kneading means.

In a further preferred embodiment, the apparatus comprises a thermoregulating barrel being a kneading vessel comprising a double wall.

It is clear that the apparatus of the second independent aspect is ideally suited for performing the method of the first aspect and/or the preferred embodiments thereof, and that the apparatus of the second independent aspect may show correspondingly preferred features.

With the intention of better showing the characteristics according to the invention, in the following, as an example without limitative character, some embodiments are described, with reference to the accompanying drawings, wherein:

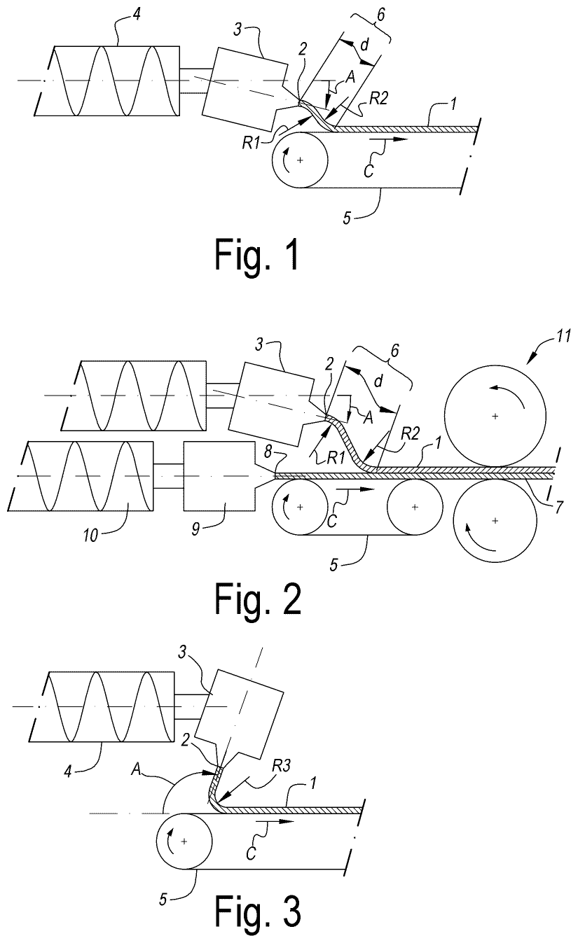

FIG. 1 shows schematically a method for manufacturing an extruded sheet according to the first aspect of the invention;

FIGS. 2 to 6 show alternatives in a view similar to that of FIG. 1.

FIG. 1 shows a method for manufacturing an extruded sheet 1 wherein said sheet 1 is extruded through the opening 2 of a die 3, said die 3 being fed by an extruder 4. The extruded sheet, after leaving the opening 2 of the die 3, is laid down on at least a first supporting means 5. The motion C of the extruded sheet 1 along said first supporting means 5. For ease of reference, the direction of motion C is shown as pointing to the right, in all figures.

According to the invention said die 3 forms an inclination angle A with the horizontal plane. Said inclination angle A in FIG. 1 is an acute angle of about 15°, as measured from the horizontal plane as the angle base in a clockwise direction. As shown in FIG. 1, in such case, the opening 2 of the die 3 is pointing downwards. In this embodiment, said extruded sheet 1 is being laid down onto said first supporting means 5 in a transitional let-down trajectory 6. The sheet 1 is supported within a distance d, as measured along the length of the sheet, wherein the distance d is preferably 25 cm or less. Or in other words, the length d of the let-down trajectory is preferably 25 cm or shorter.

In FIG. 1, said first supporting means 5 is a conveyor belt 5, which conveyor belt extends vertically below the opening 2 of the die 3, meaning that the conveyor belt 5 is at least partially underneath the opening 2 of the die 3. Said sheet 1 in said transitional let-down trajectory 6 is bent. As shown in FIG. 1, the sheet 1 in said transitional let-down trajectory 6 is bent with radiuses R1 and R2, and wherein said radiuses R1 and R2 are preferably both of 10 cm or more.

FIG. 2 shows an alternative embodiment, which alternative includes providing an additional sheet 7, wherein said additional sheet 7 is extruded through the opening 8 of an additional die 9, said additional die 9 in the present example being fed by an additional extruder 10. The additional die 9, as shown in FIG. 2, may be in the horizontal plane and/or the sheet 7 may leave the opening 8 of the additional die 9 in the horizontal plane, or in a direction that is at least less inclined than the direction in which the sheet 1 leaves the opening 2 of the die 3. The sheet 1, let down by the inclined die 3, is bent with radiuses R1 and R2 in a transitional let-down trajectory 6. The first supporting means 5 is a conveyor belt 5, which conveyor belt extends vertically below the inclined die 3. The inclined die has the opening 2 facing in the direction of the motion C of the first supporting means 5, and the inclined die 3 forms an acute inclination angle A of about 15°, measured clockwise from the horizontal plane as the angle base. The length d of the sheet 3 in its transitional let-down trajectory 6 is preferably below 25 cm. Once that sheets 1, 7 are extruded, said sheets 1, 7 are pressed and/or laminated together using a pressing device 11.

FIG. 3 shows another alternative embodiment, wherein the inclination angle A is an obtuse angle of about 110°, i.e. wherein the opening 2 of the die 3 faces awayfrom the direction of the motion C of the first supporting means 5. The first supporting means in FIG. 3 is a conveyor belt 5, which conveyor belt 5 extends vertically below the opening 2 of the die 3, meaning that said conveyor belt 5 is at least partially positioned beneath said opening 2 of the die 3. As shown in FIG. 3, the sheet 1 let down by an inclined die 3, in this alternative embodiment, is bent with a radius R3. The radius R3 is preferably of 10 cm or more.

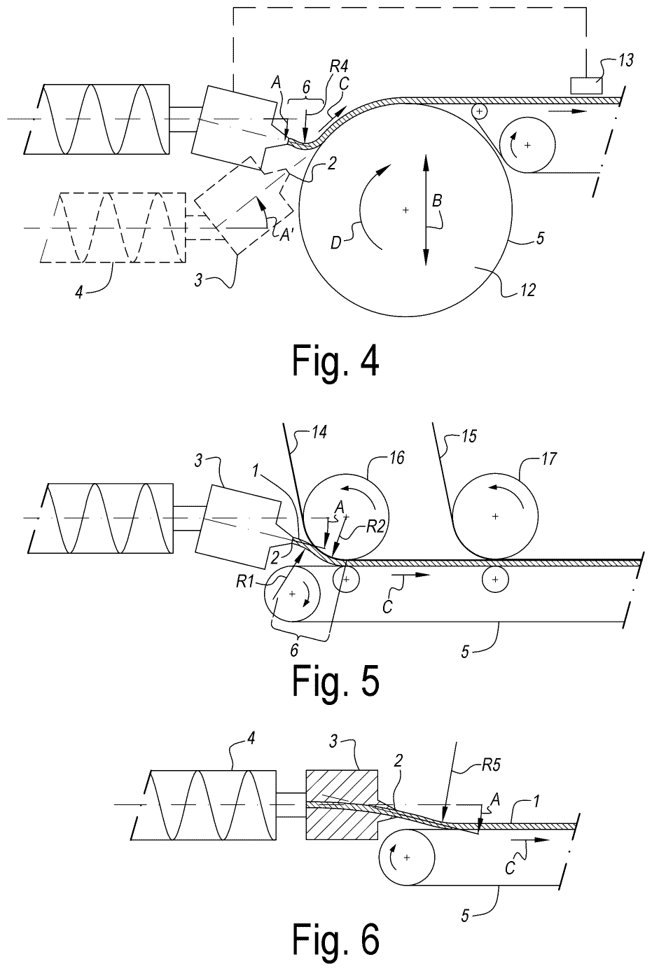

FIG. 4 shows two alternative embodiments, wherein the sheet 1 is extruded against a roller 12, said roller 12 being a first supporting means 5. In the first illustrated embodiment, shown in full line in FIG. 4, the die 3 of an extruder 4 is inclined by an angle A of about 15°, measured clockwise from the horizontal plane as the angle base.

FIG. 4, in a dashed line, shows a second illustrated embodiment, wherein a die 3 of an extruder 4 is arranged so that said inclined die 3 extrudes the sheet 1 tangentially onto the roller 12. The die 3 is inclined with an angle A′ of about 40°, measured counterclockwise starting from a horizontal plane as the angle base, i.e. the opening 2 of the die 3 is pointing upwards.

FIG. 4 further illustrates, with the arrow B, that the first supporting means 5, in this case the roller 12, may be positionable, and/or, as illustrated with the arrow D, may be driven and/or braked. With said positioning, a control of the let-down trajectory 6 may be obtained. For example, in case of said first illustrated embodiment, with such positioning of the roller 12 a better control of the bending of the sheet 1 with a radius R4 may be achieved. For example, in case of said second illustrated embodiment, the position of the roller 12 may be controlled to maintain the tangentiality of the direction in which the sheet 1 leaves the opening 2 and the roller 12, even in cases where said inclination angle A′ is adjusted during extrusion. Even though the arrows B illustrated a positioning along the vertical plane, it is clear that alternatively, or in combination therewith, a positioning along the horizontal plane may be obtained. With said braking and/or pulling the extrusion of sheet 1 may be assisted and/or counteracted by pulling and/or pushing the extruded sheet 1. It is clear that the ability to position any supporting means, such as a first supporting means 5, is of interest in any embodiment where the inclination of the die 3 and/or the direction in which the sheet 1 leaves the opening 2 of the die 3 is adjustable.

FIG. 4, further illustrates the inclusion of a measuring device 13, which device 13 may be used to measure the parameters of the sheet 1 such as density, thickness, etc. The measurement data may be used to adjust the inclination of the die 3 and/or the direction in which the sheet 1 leaves the opening 2 of the die 3, and/or to adjust the position of any positionable supporting means, such as the first supporting means 5 or the roller 12. It is clear that such measuring device 13 may be applied in any embodiment where the inclination of the die 3 and/or the direction in which the sheet 1 leaves the opening 2 of the die 3 is adjustable.

The measurement device 11 may for example be an X-ray measurement device and/or an ultrasonic measurement device.

FIG. 5 shows another alternative embodiment, which alternative further comprises providing of a decorative layer 14 and a wear layer 15, which layers 14, 15 are laminated and/or pressed onto the extruded sheet 1 using first and second pressing devices 16, 17, respectively. The extruded sheet 1 is extruded onto a side of the first pressing device 16, whereby a radius R2 of bending of the sheet 1 in the let-down trajectory 6 is at least in part determined by said pressing device 16. The first supporting means 5 as shown in FIG. 5 is a conveyor belt 5, which conveyor belt extends vertically below the opening 2 of the inclined die 3, meaning that said conveyor belt 5 is at least partially positioned beneath the opening 2 of said die 3. In the particular embodiment shown in FIG. 5, the die 3 or the direction in which the sheet 1 leaves the opening 2 of the die 3 is inclined by an acute angle A of about 15° as measured in a clockwise direction starting from a horizontal plane as the angle base. The opening 2 of the die 3 is pointing downwards and substantially in the direction of the motion C of the first supporting means 5.

It is clear that any of the illustrated and non-illustrated embodiments may further comprise a step wherein a decorative layer 14 and/or a wear layer 15 is directly or indirectly attached to said sheet 1. The decorative layer 14 and/or the wear layer 15 need not necessarily be preformed as layers, but may be applied through printing and/or applying directly on the sheet 1, with or without intermediate layers, such as priming and/or background layers. The obtained coated panels form examples of the additional particular independent aspect mentioned in the introduction.

FIG. 6 shows another alternative embodiment, wherein the sheet 1 is extruded through the opening 2 of a die 3, said die 3 being fed by an extruder 4. In this embodiment the direction in which the extruded sheet 1 leaves said opening 2 forms an inclination angle A with respect to the horizontal plane. Said inclination angle A is an acute angle of about 15°, as measured clockwise from the horizontal plane as the angle base. The sheet 1 is laid down on a conveying means 5 wherein a radius R5 of bending of the sheet 1 is preferably of 10 cm or more. In contrast to the embodiments illustrated in FIGS. 1 to 5, the die 2 or its axis does not appear to be inclined in itself. However, the path followed by the material to be extruded follows a non-horizontal, in this case partially inclined, path, as shown by means of the cross-section of the die 3. Due to this particular path within the die 3, the sheet 1 leaves the opening 2 of the die 3 in a direction that forms an inclination angle A with the horizontal plane.

It is clear that the apparatuses illustrated in the figures are embodiments in accordance with the second independent aspect as mentioned in the introduction.

The present invention is not limited to the preferred embodiments described here above, but such methods and apparatuses may be realized according to several variants without leaving the scope of the invention.

1-46. (canceled)

47. A method for manufacturing an extruded sheet, wherein said sheet is extruded through an opening of a die, said die being fed by an extruder,
wherein said die forms an inclination angle with the horizontal plane,
wherein said extruded sheet comprises an extruded polymer composition,
wherein said polymer composition comprises polymer powder, filler materials and additives, and said method further comprises the steps of:
providing a decorative layer and a wear layer, which decorative layer and wear layer are passed over at least a calendaring roll; and
pressing said decorative layer and said wear layer together with the sheet in order to form a panel.

48. The method of claim 47, wherein said inclination angle is from 1° to 60°, wherein said inclination angle is an acute angle, as measured clockwise starting from said horizontal plane as angle base.

49. The method of claim 47, wherein said sheet is laid down on a first supporting means,
wherein said first supporting means extends vertically underneath said opening of said die.

50. The method of claim 49, wherein said laying down of said extruded sheet is done in a transitional let-down trajectory,
wherein said sheet in said transitional let-down trajectory is bent.

51. The method of claim 50, wherein said sheet during said let-down trajectory is bent with radiuses 10 cm or more.

52. The method of claim 49, wherein said sheet is laid down by means of a roller having a radius of 10 cm or larger and/or on a conveyor belt.

53. The method of claim 47, wherein said inclination angle is adjustable and/or variable during said extruding of said sheet.

54. The method of claim 47, wherein said method includes providing of an additional sheet
wherein said additional sheet is extruded through the opening of an additional die, said additional die being fed by an additional extruder,
wherein said additional die is in the horizontal plane.

55. The method of claim 54, wherein said additional sheet is of a different composition relative to the sheet extruded by the die forming an inclination angle with the horizontal plane.

56. The method of claim 47, wherein the method further comprises the step of calibrating and/or compressing of the sheet while still warm to obtain a desired thickness.

57. The method of claim 47, wherein said polymer composition comprises filler material in amount 50-90 wt. %, and a polymer in amount of 10-40 wt. %.

58. The method of claim 47, wherein said sheet is or comprises a foamed layer, wherein said foamed layer is a closed cell foam.
